(19) United States
(12) Patent Application Publication
(10) Pub. No.: US 2018/0224329 A1
(43) Pub. Date: Aug. 9, 2018

(54) PROBE BASED ROLLING OPTIC HYPERSPECTRAL DATA COLLECTION SYSTEM

(71) Applicant: Corning Incorporated, Corning, NY (US)

(72) Inventors: William Spencer Klubben, III, Corning, NY (US); Horst Schreiber, Livonia, NY (US)

(21) Appl. No.: 15/886,075

(22) Filed: Feb. 1, 2018

Related U.S. Application Data
(60) Provisional application No. 62/456,756, filed on Feb. 9, 2017.

(51) Int. Cl. G01J 3/02; G01J 3/18; G01J 3/28

(52) U.S. Cl. CPC G01J 3/0208; G01J 3/18; G01J 2003/2826; G01J 3/0256; G01J 3/2823; G01J 3/0272

(57) ABSTRACT

A hyperspectral imaging system for imaging a patient or object is provided. In one embodiment, the hyperspectral imaging system includes a housing having a proximal end and a distal end. The hyperspectral imaging system also includes a fore-optics module coupled to the proximal end of the housing wherein the fore-optics module is configured to receive an electromagnetic signal from the patient. The hyperspectral imaging system additionally includes a wavelength-dispersing module coupled inside the housing and a detector coupled to the distal end of the housing. The fore-optics module may include a rolling optical lens.

This application claims the benefit of priority under 35 U.S.C. § 119 of U.S. Provisional Application Ser. No. 62/456,756 filed on Feb. 9, 2017 the content of which is relied upon and incorporated herein by reference in its entirety.

### TECHNICAL FIELD

The present disclosure relates to hyperspectral imaging. More particularly, embodiments described herein relate to a compact and lightweight hyperspectral imager that includes fore-optics interfaced with a spectrometer.

### BACKGROUND

Hyperspectral imaging is emerging as the leading technique for remote imaging and detection. Applications of hyperspectral imaging include medical diagnosis, airborne reconnaissance in military and aerospace applications, environmental monitoring, agricultural monitoring, geological surveying, and mineral exploration.

Hyperspectral imaging systems measure the spectral features of objects in real-world scenes. Typically, the scene is broken into a grid and a spectrum is measured for each element of the grid. The spectrum typically consists of light reflected and/or scattered from objects in the scene. During imaging, the scene of interest is divided into slices and each slice is imaged separately. The image of the scene is acquired by sequentially sampling the slices.

Hyperspectral image acquisition involves acquiring spectra for each slice of the scene over a wide range of wavelengths. The wide wavelength range is desirable because different objects in the scene reflect or scatter light at multiple wavelengths. By acquiring spectral data over a wide wavelength range, it becomes possible to identify and discriminate between different objects in a scene with greater precision. To improve the quality of the hyperspectral image, it is necessary to insure high spatial resolution and high wavelength resolution. High wavelength resolution is achieved in hyperspectral imaging by dividing the detected wavelength range into a series of narrow contiguous wavelength bands and detecting each band separately. The wavelength bands in hyperspectral imaging may be 10nm or less. Acquiring spectra over the series of narrow wavelength bands provides more detail about the objects in the scene and allows for accurate fingerprinting of individual objects. The ability to narrow the wavelength range of detected spectral bands has been made possible by recent advances in detector design, image processing, and data storage.

The current methods used for hyperspectral imaging include a variety of techniques using devices that are becoming more compact and transportable. Although these various techniques are becoming better suited for a wide range of uses, improved efficiency and convenience are needed and desired by users across the various applications using hyperspectral imaging.

### SUMMARY

According to one embodiment, a hyperspectral imaging system is provided. The hyperspectral imaging system includes a fore-optics module configured to receive an electromagnetic signal from an object, the fore-optics module comprising a rolling optical lens, a wavelength-dispersing module configured to receive the electromagnetic signal form the fore-optics module, and a detector configured to receive the electromagnetic signal from the wavelength-dispersing module.

According to another embodiment, a method of acquiring an image from an object is provided. The method of acquiring an image from an object includes providing a hyperspectral imaging system. The hyperspectral imaging system includes a fore-optics module comprising a rolling optical lens, a wavelength-dispersing module, and a detector. The method for acquiring an image further includes rotating the rolling optical lens over the object.

According to yet another embodiment, a method of acquiring an image is provided. The method of acquiring an image includes providing a hyperspectral imaging system. The hyperspectral imaging system includes a fore-optics module comprising a rolling optical lens, the fore-optics module is configured to receive an electromagnetic signal from an object, an Offner spectrometer configured to receive the electromagnetic signal from the fore-optics module, and a detector configured to receive the electromagnetic signal from the Offner spectrometer. The method of acquiring an image further includes rotating the rolling optical lens over the object, the rotating including acquiring the electromagnetic signal from the object and directing the electromagnetic signal acquired by the rolling optical lens to a slit of the Offner spectrometer, the electromagnetic signal passing through the Offner spectrometer to the detector.

The present description extends to:

### A Hyperspectral Imaging System, Comprising:

a fore-optics module, configured to receive an electromagnetic signal from an object, the fore-optics module comprising a rolling optical lens;

a wavelength-dispersing module configured to receive the electromagnetic signal from the fore-optics module; and

a detector configured to receive the electromagnetic signal from the wavelength-dispersing module.

The present description extends to:

### A Method of Acquiring an Image, the Method Comprising:

providing a hyperspectral imaging system, the hyperspectral imaging system comprising:
a fore-optics module comprising a rolling optical lens;
a wavelength-dispersing module ; and
a detector; and

rotating the rolling optical lens over the object.

The present description extends to:

### A Method of Acquiring an Image, the Method Comprising:

providing a hyperspectral imaging system, the hyperspectral imaging system comprising:
a fore-optics module comprising a rolling optical lens, the fore-optics module configured to receive an electromagnetic signal from an object;
an Offner spectrometer configured to receive the electromagnetic signal from the fore-optics module; and
a detector configured to receive the electromagnetic signal from the Offner spectrometer; and

rotating the rolling optical lens over the object, the rotating including acquiring the electromagnetic signal from the object; and

directing the electromagnetic signal acquired by the rolling optical lens to a slit of the Offner spectrometer, the electromagnetic signal passing through the Offner spectrometer to the detector.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a schematic representation of a hyperspectral imaging system according to one embodiment;

FIG. 2 is a schematic representation of a hyperspectral imaging system according to another embodiment;

FIG. 3 is a schematic representation of a hyperspectral imaging system according to yet another embodiment;

FIG. 4A is a schematic representation of a hyperspectral imaging system having a cylindrical lens according to one embodiment;

FIG. 4B is a schematic representation of a hyperspectral imaging system having a spherical lens according to one embodiment;

FIG. 4C is a schematic representation of a hyperspectral imaging system having an aspherical lens according to one embodiment;

FIG. 4D is a schematic representation of a hyperspectral imaging system having a ball lens according to one embodiment;

FIG. 5 is a schematic representation of a hyperspectral imaging system having a rolling optical lens being rolled across a patient according to one embodiment;

FIG. 6 is a schematic flow diagram illustrating a method for acquiring an image from a patient according to one embodiment; and

FIG. 7 is a schematic flow diagram illustrating a method for acquiring an image from a patient according to another embodiment.

### DETAILED DESCRIPTION

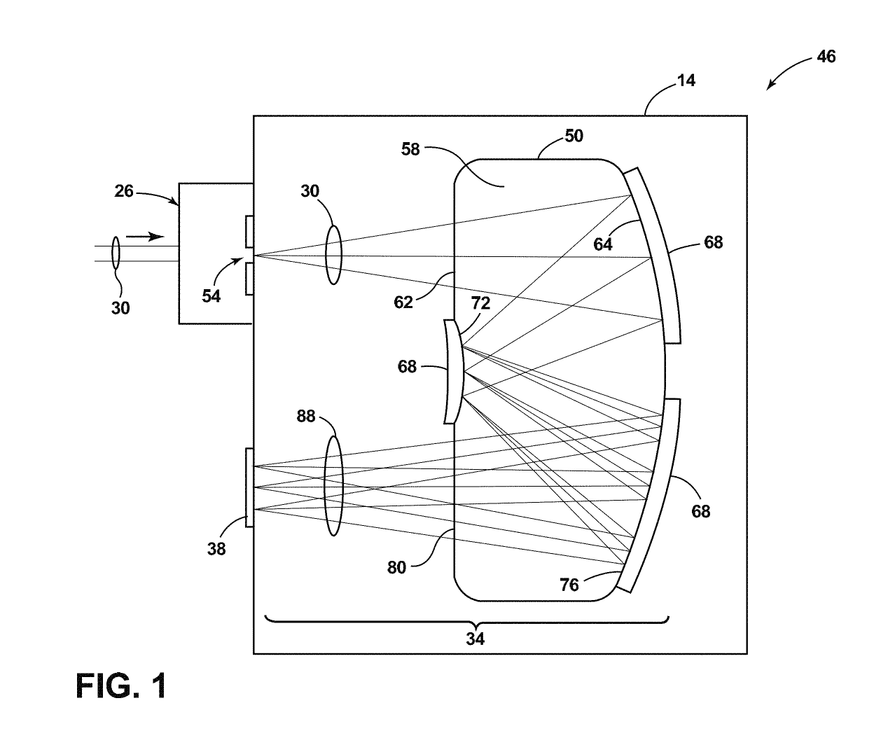

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

Reference will now be made in detail to the present embodiments, examples of which are illustrated in the accompanying drawings. Whenever possible, the same reference numerals will be used throughout the drawings to refer to the same or like parts.

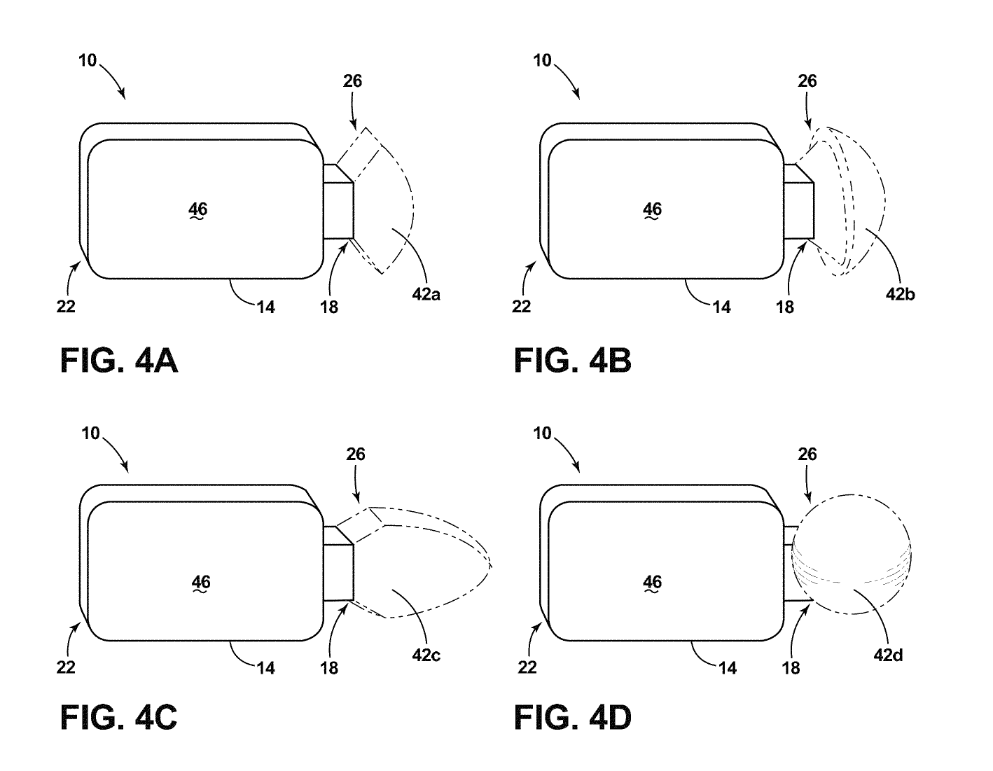

Referring now to FIGS. 1-4D, a hyperspectral imaging system 10 (FIGS. 4A-4D) for imaging an object is provided. The hyperspectral imaging system 10 includes a hyperspectral camera 46 optically coupled to a fore-optics module 26. Hyperspectral camera 46 includes a housing 14 having a proximal end 18 and a distal end 22. The fore-optics module 26 is coupled to the proximal end 18 of the housing 14 and is configured to receive an electromagnetic signal 30 from the object. The hyperspectral camera 46 includes a wavelength-dispersing module 34 coupled inside the housing 14 and a detector 38 coupled to the distal end 22 of the housing 14 (FIGS. 1-3). The fore-optics module 26 includes a rolling optical lens 42. As used herein, a rolling optical lens is a lens having a curved surface that is exposed, capable of being placed in direct contact with the object being imaged and capable of being rotated while in direct contact with the object being imaged to increase the scanning area. Embodiments of rolling optical lens 42 include a cylindrical lens 42a (FIG. 4A), a spherical lens 42b (FIG. 4B), an aspherical lens 42c (FIG. 4C), and a ball lens 42d (FIG. 4D).

The present disclosure provides a compact hyperspectral imaging system 10 suitable for weight- or space-constrained applications. The hyperspectral imaging system 10 includes the fore-optics module 26 and the hyperspectral camera 46 that includes the wavelength-dispersing module 34. The hyperspectral imaging system 10 may also include the detector 38 and supporting electronics. The fore-optics module 26 includes the rolling optical lens 42. The wavelength-dispersing module 34 may be a spectrometer. The detector 38 may be a sensor, camera, focal plane array or other device capable of detecting electromagnetic signals in the visible and near-infrared (NIR or SWIR) portions of the spectrum. The supporting electronics may aid in positioning the fore-optics module 26, operating the wavelength-dispersing module 34, or operating the detector 38. The supporting electronics may include memory to store image data or imaging software, and one or more microprocessors to run imaging software.

The fore-optics module 26 and wavelength-dispersing module 34 may be operatively coupled along a common optical path. The wavelength-dispersing module 34 and detector 38 may also be operatively coupled along a common optical path. The fore-optics module 26 acquires image data from a scene and directs it to the wavelength-dispersing module 34, which resolves the image data according to wavelength and directs it to the detector 38 to sense, quantify, and/or record the image data.

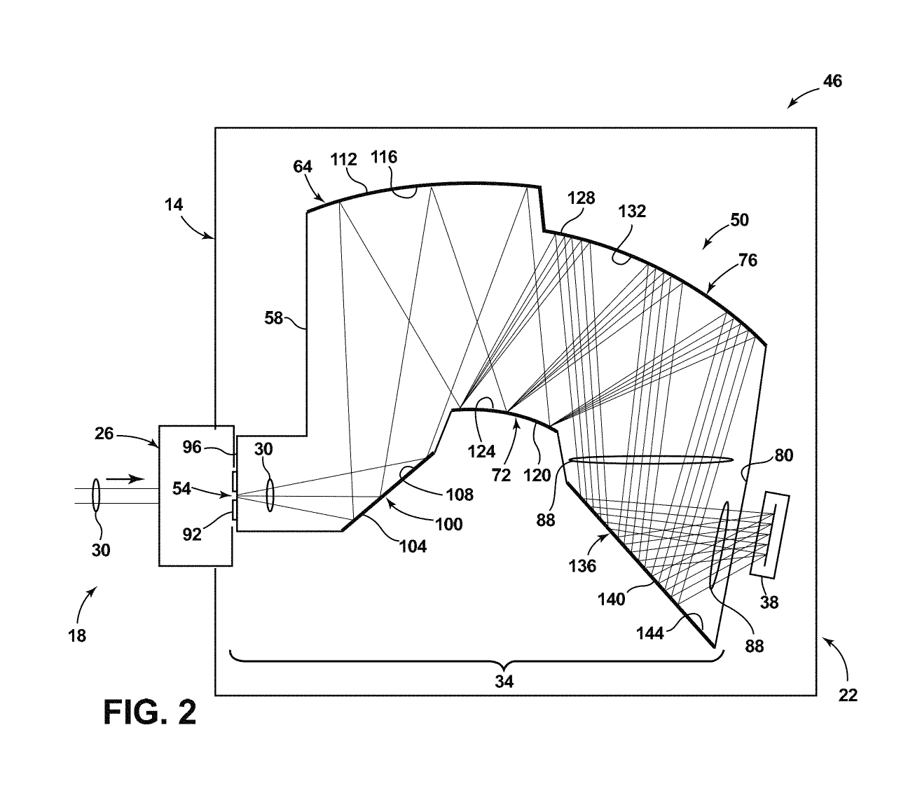

The hyperspectral imaging system 10 acquires image data in the form of electromagnetic signals from real world scenes and objects and provides sufficient resolution to permit discrimination between objects in the scene on the basis of electromagnetic signal. In some embodiments, the object or real world scene may include the patient, a biological tissue, a biological organ, a mammal, a vertebrate, an invertebrate, a surface, or any other object able to transmit or reflect electromagnetic signals 30. The fore-optics module 26 acquires the electromagnetic signal 30 reflected by, radiated by, emitted by, scattered by, and/or otherwise emanating from the patient or object in the scene. In one embodiment, the fore-optics module 26 receives the electromagnetic signal 30 from the patient or object in the scene and focuses it on a slit 54 of the wavelength-dispersing module 34 (FIGS. 1 and 2). The fore-optics module 26 includes the rolling optical lens 42.

The wavelength-dispersing module 34 receives electromagnetic signal 30 from the fore-optics module 26 and separates or disperses it according to wavelength. The wavelength-dispersing module 34 may include optics such as diffraction gratings, prisms, lenses, and mirrors. The wavelength-dispersing module 34 may be a spectrometer. The spectrometer may be an Offner spectrometer 50 (shown in FIG. 1). The Offner spectrometer 50 is a particularly compact spectrometer that enables miniaturization of the hyperspectral imaging system 10. An example of the Offner spectrometer 50 is described in U.S. Pat. No. 7,697,137, the disclosure of which is hereby incorporated by reference in its entirety herein.

The wavelength-dispersing module 34 may direct light to the detection element or detector 38. The detection element 38 detects the wavelength, intensity, polarization or other characteristic of the electromagnetic signal 30 dispersed by the wavelength-dispersing element. The detection element may be a photodetector, a CCD device, a diode array, a focal plane array, a CMOS device, or any other type of image detector known in the art for sensing electromagnetic radiation reflected over the wavelength range associated with physical objects in real-world scenes.

Referring now to FIG. 1, an embodiment of the hyperspectral imaging system 10 is depicted. A hyperspectral camera 46 includes an Offner spectrometer 50 coupled within the housing 14. The hyperspectral camera 46 includes the slit 54 and the detector 38 attached to the housing 14. In the embodiment shown, the wavelength dispersing module 34 is a spectrometer, specifically the spectrometer is an Offner spectrometer 50. The Offner spectrometer 50 is a one-one optical relay made from a single piece of transmissive material 58 including an entrance surface 62, a first mirror 64 (formed when a reflective coating 68 is applied as shown to the surface of transmissive material 58), a diffraction grating 72 (formed when the reflective coating 68 is applied as shown to the surface of transmissive material 58), a second mirror 76 (formed when the reflective coating 68 is applied as shown to the surface of transmissive material 58) and an exit surface 80. In some embodiments, the Offner spectrometer includes a slit 54 configured for receiving and passing the electromagnetic signal 30 to an entrance surface 62 of the fore-optics module 26, a first mirror 64 configured for receiving and reflecting the electromagnetic signal 30 passed through the slit 54, a diffraction grating 72 configured for receiving and diffracting the electromagnetic signal 30 reflected by the first mirror 64, and a second mirror 76 configured for receiving and reflecting the electromagnetic signal 30 diffracted by the diffraction grating 72.

The hyperspectral imaging system 10 of the present disclosure operates to produce images of the patient or object (not shown) over a contiguous range of narrow spectral bands when the slit 54 receives the electromagnetic signal 30 from the patient or object through the fore-optics module 26 and directs the electromagnetic signal 30 to the Offner spectrometer 50. Offner spectrometer 50 diffracts the electromagnetic signal 30 and forwards the diffracted electromagnetic signal 88 to the detector 38. In particular, the slit 54 directs the electromagnetic signal 30 to the entrance surface 62 of the transmissive material 58. First mirror 64 receives the electromagnetic signal 30 transmitted through the entrance surface 62 and reflects the electromagnetic signal 30 towards the diffraction grating 72. The diffraction grating 72 receives the electromagnetic signal 30 and diffracts and reflects the diffracted electromagnetic signal 88 to the second mirror 76. The second mirror 76 receives the diffracted electromagnetic signal 88 and reflects the diffracted electromagnetic signal 88 to the exit surface 80 of the transmissive material 58. The detector 38 processes the diffracted electromagnetic signal 88 received from exit surface 80.

Transmissive material 58 is selected to have high transparency over the target range of wavelengths acquired from the scene during imaging. Wavelengths of interest may include near infrared wavelengths, visible wavelengths, and/or ultraviolet wavelengths. Materials suitable for transmissive material 58 include plastics, dielectrics, and gases. Representative materials include PMMA, polystyrene, polycarbonate, silicon, germanium, ZnS, ZnSe, CaF₂, air, nitrogen, argon, and helium. When a solid phase material is employed as the transmissive material 58, the Offner spectrometer 50 may be referred to herein as a monolithic Offner spectrometer. When a gas phase material is employed as the transmissive material 58, the Offner spectrometer 50 may be referred to herein as a reflective Offner spectrometer. In the reflective Offner spectrometer design, the first mirror 64, the diffraction grating 72, and the second mirror 76, are coupled to the housing 14 through posts or other mounts. Use of a gas as the transmissive material 58 may facilitate the objective of minimizing the weight of the hyperspectral imaging system 10. Many gases also exhibit high transparency in the visible and near-infrared portions of the spectrum.

Detector 38 is selected to have a wavelength sensitivity based on the type of transmissive material 58 used to make the Offner spectrometer 50. For instance, if the transmissive material 58 of the Offner spectrometer 50 were made from a plastic, (e.g., polymethylmethacrylate (PMMA), polystyrene, polycarbonate) then the diffracted wavelength range would be primarily in the visible and the detector 38 may be a complementary metal-oxide-semiconductor (CMOS) video camera. If the transmissive material of the monolithic Offner spectrometer 50 were made from an infrared transmitting material, then the detector 38 may be an IR detector, such as one based on mercury cadmium telluride (HgCdTe), indium antimonite (InSb) or lead sulfide (PbS).

The hyperspectral imaging system 10 may further include additional optics to receive or direct the electromagnetic signal 30 and/or diffracted electromagnetic signal 88 to or from different directions to permit flexible positioning of slit 54 and/or detector 38 with respect to the housing 14.

The hyperspectral imaging system 10 may include a data processor to process image data embodied in electromagnetic signals acquired from the scene. The image data may include spectral data, wavelength data, polarization data, intensity data, or positional data. The data processor may receive image data from the detection element and transform or otherwise manipulate image data into a form specified by the user. Data processing may include conversion of image data to any of several visual forms known in the art and may include coloring, shading, or other visual effects intended to represent position, depth, composition, or other features of objects in the scene. Data received and/or processed by the hyperspectral imaging system 10 may be transferred to a display device for further processing and/or display. The display device may be integrated directly within the hyperspectral imaging system 10 or may be at a remote position. The data transfer may occur through a data interface, such as a data link or USB connection. The hyperspectral imaging system 10 may also include memory. The memory may be used to store image data or processing software. The image data may be unprocessed or processed image data. Image data stored in the hyperspectral imaging system 10 may be downloaded to an external computer for processing. Image data stored in the hyperspectral imaging system 10 may be processed online or offline.

The hyperspectral imaging system 10 may include a battery module. The battery module may include a rechargeable battery and may be removably coupled to the hyperspectral imaging system 10. Battery power may also be provided by a battery contained within the mobile display device. The hyperspectral imaging system may also be adapted to receive power from an external battery.

The fore-optics module 26 may be configured as a forward-looking design or a downward-looking design. In a forward-looking design, the fore-optics module 26 acquires image data in a direction aligned or substantially aligned with the direction of the longest linear direction of the housing 14. In a downward-looking design, the fore-optics module 26 acquires image data in a direction normal or substantially normal to the longest linear dimension of the housing 14. If the housing 14 is cylindrical in shape with a length that exceeds the diameter, for example, the longest linear dimension of the housing 14 is the length direction and a forward-looking fore-optics module 26 is positioned to view images along the length direction of the housing 14 (e.g., through an opening in the circular end of the cylinder). A downward-looking fore-optics module 26, in contrast, is positioned to view images along the radial direction of the housing 14 (e.g., through an opening in the sidewall of the cylinder). A forward-looking fore-optics module 26 may acquire image data from a direction parallel or substantially parallel to the ground. A downward-looking fore-optics module 26 may acquire image data from a direction normal or substantially normal to the ground.

Referring now to FIG. 2, there is a schematic representation of another embodiment of the hyperspectral imaging system 10 which incorporates a monolithic Offner spectrometer 50 that is configured and manufactured in accordance with yet another embodiment of the present disclosure. It is understood that the descriptions outlining and teaching the hyperspectral imaging system 10 previously discussed in FIG. 1, which can be used in any combination, may be applied equally as well to the embodiment of the hyperspectral imaging system 10 represented in FIG. 2. The hyperspectral imaging system 10 has the fore-optics module 26 and the detector 38 positioned at the proximal end 18 and the distal end 22 of the housing 14 of hyperspectral camera 46, respectively. In this embodiment, the fore-optics module 26 is coupled to the wavelength-dispersing module 34 or the monolithic Offner spectrometer 50. In other embodiments, the fore-optics module 26 is coupled to the housing 14 surrounding the wavelength-dispersing module 34 or the monolithic Offner spectrometer 50. The housing 14 encloses or protects the wavelength-dispersing module 34 or Offner spectrometer 50. For instance, the housing 14 may be a standard detector dewar which not only protects but also functions to insulate the monolithic Offner spectrometer 50.

The Offner spectrometer 50 provided in FIG. 2 is a one-one optical relay made from the single piece of transmissive material 58 including: (1) the slit 54 formed when an opaque material 92 is applied to an entrance portion/portion exposed 96 of the transmissive material 58 where the opaque portion 92 has a portion removed therefrom to form the slit 54; (2) a first fold mirror 100 formed when a first reflective coating 104 is applied to a first surface 108 of transmissive material 58; (3) the first mirror 64 formed when a second reflective coating 112 is applied to a second surface 116 of transmissive material 58; (4) the diffraction grating 72 formed when a third reflective coating 120 is applied to a third surface 124 of transmissive material 58; (5) the second mirror 76 formed when a fourth reflective coating 128 is applied to a fourth surface 132 of transmissive material 58; (6) a second fold mirror 136 formed when a fifth reflective coating 140 is applied to a fifth surface 144 of transmissive material; and (7) the exit surface 80 of transmissive material 58. Incident electromagnetic signal 30 is directed through wavelength-dispersing module 34 to provide a diffracted electromagnetic signal 88 that is detected by detector 38. Additional designs and layouts for the optical relays may be utilized by those skilled in the art as required by the application and the respective dimensions of the environment to image.

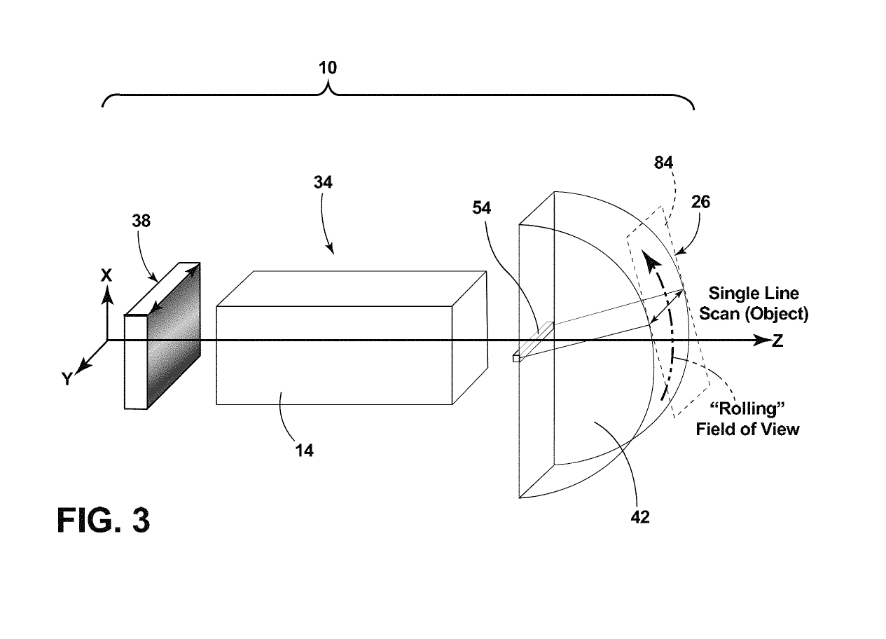

Referring now to FIG. 3, a schematic representation is shown for one embodiment of the hyperspectral imaging system 10. The hyperspectral imaging system 10 includes the fore-optics module 26 shown as the embodiment in which the rolling optical lens 42 is a cylindrical lens. The disclosure herein uses a rolling optical lens 42 to collect imaging and spectral data. By nature of the spherical or rounded surface of the rolling optical lens 42, the electromagnetic signal 30 transmitted and/or reflected from the patient is collected perpendicular to the normal of a surface 84 being imaged with respect to the hyperspectral imaging system 10 and will be focused to the center of the radius where the slit 54 will be located. As a user rotates the rolling optical lens 42 along the surface 84 being analyzed, a line scan will be collected at each angle of rotation as shown in FIG. 3. Collection of the line scan includes acquiring an electromagnetic signal from the patient, object, or scene and directing the electromagnetic signal 30 to the fore-optics module 26.

Ideally only a single line scan will be collected per unit of time, as the rolling optical lens 42 is rotated across the surface regions of interest. However, it is possible that a given surface will slightly conform to or adhere to the rolling optical lens 42, especially in the case of soft biological tissue, thus limiting the capability of the rolling optical lens 42 to detect single line scans. This would result in multiple line scans entering the slit 54 simultaneously causing a potential decrease in image quality. To combat this possible problem, a movable/sliding slit 54 may be used to better define each of the lines scanned. The movable/sliding slit 54 may offer multiple possible solutions: a moveable/sliding slit 54 that may be mechanically/electronically controlled using a gyroscopic feedback system or an accelerometer (so that the position of the rolling optical lens 42 is known and the slit 54 is moved accordingly); a weighted slit 54 that may freely move from the effects of gravity (the slit 54 will position itself in whichever portion of the rolling optical lens 42 that is closest to the center of the earth), or the hyperspectral imaging system 10 may be designed in anticipation that soft biological tissue will conform to or adhere to the rolling optical lens 42 and the moveable slit 54 may mechanically move through the entire field of view as the fore-optics module 26 is placed on a given surface (in this embodiment, the rolling optical lens 42 would no longer require a rotating motion). Additionally, an illumination system (not shown) for this device could shift as a function of the rolling angle to help select which line scan will be imaged, thus increasing the signal to noise ratio.

Referring now to FIG. 4A-4D, a variety of different rolling optical lenses 42a, 42b, 42c, 42d are represented. For example, in some embodiments, the rolling optical lens 42 may be the cylindrical lens 42a representing a slice of a cylinder where the slice has flat top and bottom sides with an arched edge extending out away from the proximal end 18 of the housing 14 as shown in FIG. 4A. In other embodiments, the rolling optical lens 42 may be the spherical lens 42b where a portion of a sphere is coupled to the proximal end 18 of the housing 14 as shown in FIG. 4B. FIG. 4C shows the aspherical lens 42c being used for the rolling optical lens 42 where the aspherical lens may come to a generally rounded point. FIG. 4D represents a ball lens 42d utilized as the rolling optical lens 42. Other shapes make be used for the rolling optical lens although each of the shapes used should focus the electromagnetic signal 30 received from the patient or scene to the slit 54 to enter the wavelength-dispersing module 34.

Still referring to FIG. 4A-4D, the rolling optical lens 42 may be shaped like a section of a cylinder as shown in FIG. 4A. The ball lens of FIG. 4D may also have the same effect in collecting sections of a surface parallel to the normal of the rolling optical lens 42. Although the ball lens is possible, in some embodiments the cylinder design may better unify the pixels in the ‘y’ axis, whereas the ball lens 42d would not. Additionally, by making the rolling optical lens 42 a cylinder as shown in FIG. 4A, the rolling optical lens 42 guides the user to a single back and forth rolling motion in order to increase image clarity and prevent double images.

The rolling optical lens 42 may be made from a variety of different lens materials. The lens materials used to fabricate the rolling optical lens 42 should optimally have high transparency over the target range of wavelengths acquired from the patient or scene during imaging. Wavelengths of interest may include near infrared wavelengths, visible wavelengths, and/or ultraviolet wavelengths. Lens materials suitable for the rolling optical lens 42 include plastics, glass ceramics, aluminosilicate glass, alkali-barium silicate glass, silica glass, optical glass, and/or any other optical material known in the art. Representative materials include PMMA, polystyrene, polycarbonate, silicon, germanium, ZnS, ZnSe, CaF₂.

Using the rolling optical lens 42 as the fore-optic module 26 provides for a rolling probe-based method to collect spectral data from the surface of the patient in one embodiment, where the surface is intended to be biological tissue. The disclosure herein describes the ability to collect hyperspectral data cubes using a rolling probe based hyperspectral imaging system 10. There are many benefits of using the rolling probe-based hyperspectral imaging system 10 including: healthcare providers are already familiar with probe-based devices; the user or caregiver can directly image a variety of tissues directly on the respective tissue; and the hyperspectral imaging system 10 may be easier to clean. If the patient or the camera is required to move, the technology may be more difficult to use depending on the application or would require significantly more infrastructure to the system.

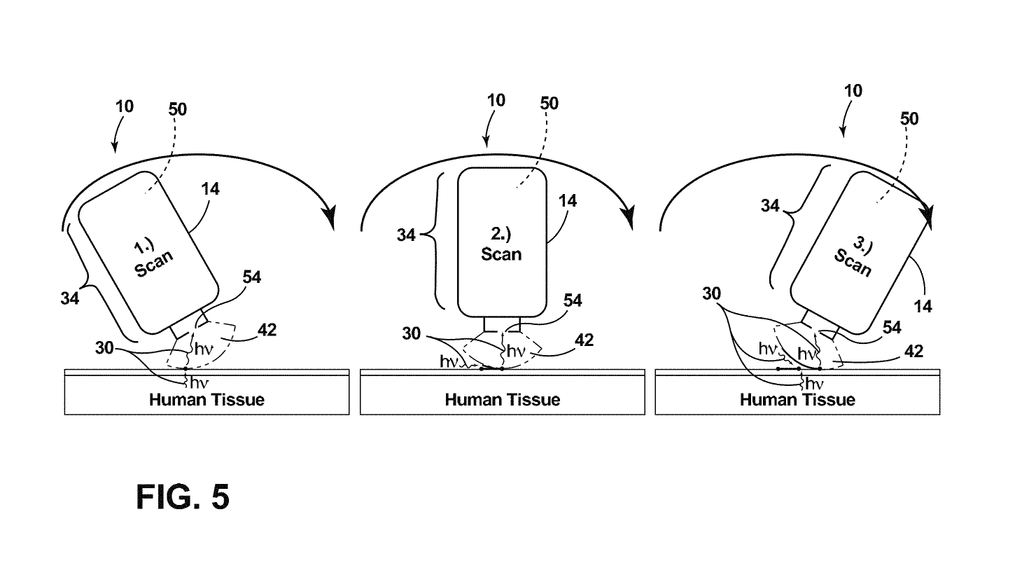

Referring now to FIG. 5, a schematic representation of a hyperspectral imaging system 10 having a rolling optical lens 42 being rotated across the patient according to one embodiment. The hyperspectral imaging system 10 of the present disclosure operates to produce images of the patient or object (not shown) over a contiguous range of narrow spectral bands when the slit 54 receives the electromagnetic signal 30 from the patient or object and directs the electromagnetic signal 30 into the wavelength-dispensing module 34, which may include Offner spectrometer 50. The hyperspectral imaging system 10 will be able to function if the electromagnetic signal 30 or illumination transmitted from the patient is either in a reflection mode and/or transmission mode. For example, in the first position of the scan shown in FIG. 5, the electromagnetic signal 30 being analyzed by the hyperspectral imaging system 10 is from the transmission of the respective electromagnetic signal 30 (or hv) through the human tissue. In the second scanning position, the respective electromagnetic signal 30 (or hv) being analyzed by the hyperspectral imaging system 10 is being reflected off of the surface of the human tissue. Lastly, the third scanning position is shown where the respective electromagnetic signal 30 (or hv) being analyzed by the hyperspectral imaging system 10 can be selected from the electromagnetic signal 30 being reflected off of the human tissue and/or from the electromagnetic signal 30 being transmitted through the same human tissue. Depending on the band of wavelength being monitored and the desired type of data or spectral image to be observed by the user or health care practitioner, either or both of the electromagnetic signal 30 sources may provide advantages.

In some embodiments, the rolling optical lens 42 may be rotated across the patient using an emersion liquid to be placed between the rolling optical lens 42 and the patient. The emersion liquid may be any gel, suspension, oil, ointment, or other material that could enhance the transmission of the electromagnetic signal 30 between the patient and/or object and the hyperspectral imaging system 10.

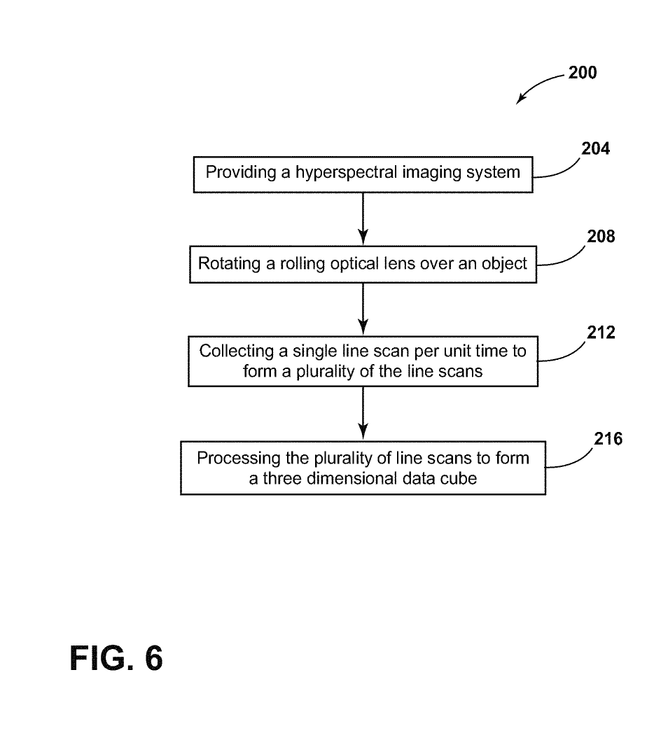

Referring now to FIG. 6, a method 200 of acquiring the image from the patient is provided. The method of acquiring the image from the patient includes providing a hyperspectral imaging system 10 in step 204. The hyperspectral imaging system 10 includes the housing 14 having the proximal end 18 and the distal end 22, the fore-optics module 26 including the rolling optical lens 42 wherein the fore-optics module 26 is coupled to the proximal end 18 of the housing 14 and wherein the fore-optics module 26 is configured to receive the electromagnetic signal 30 from the patient, the wavelength-dispersing module 34 coupled inside the housing 14, and the detector 38 coupled to the distal end 22 of the housing 14. The method of acquiring the image from the patient further includes rotating the rolling optical lens 42 over the patient in step 208, collecting a single line scan per unit time to form a plurality of line scans as the rolling optical lens 42 is rotated over the patient in step 212, and processing the plurality of line scans to form a three dimensional data space in step 216.

It is understood that the descriptions outlining and teaching the hyperspectral imaging system 10 previously discussed, which can be used in any combination, may be applied equally as well where applicable to method 200 disclosed for acquiring an image from the patient using the hyperspectral imaging system 10.

The method 200 creates hyperspectral data cubes by imaging one row of pixels, or “image slice,” at a time. When each slice is imaged, the spectral data for each pixel is also collected in another dimension, thus creating a two dimensional image from a one dimensional line of pixels. The data cube is created by collating all of the spectrally resolved image slices. In order to collect these slices, either the object or the camera must move. This requirement is advantageous for collecting images from applications in which this motion is innately present such as an airplane application (camera in motion) or a conveyer belt (object in motion). For applications in which neither the object nor the detector 38 can easily change locations, a mirror galvanometer is typically used in the art to scan the respective image. However, for some medical and healthcare applications, the probe-based user interface systems as described herein may be used as an alternative to the mirror galvanometer system.

The rolling optical lens 42 disclosed herein may be used with the wavelength-dispersing module 34 and detector 38 to create the motion of the slit 54 over the patient and this rotation of the rolling optical lens 42 can create a scan orthogonal to the slit 54 direction. Once the rolling motion is completed and the slit 54 has scanned the desired region of the patient, the hyperspectral imaging system 10 may re-create a data cube of the two dimensional image using the spectral information. The disclosure herein proposes a novel device and method for collecting light to be used in the hyperspectral imaging system 10. Current light collection methods used in the art either use a moveable stage or a mirror galvanometer to shift the reference frame. A simple objective lens is used as a fore-optic collection system imaged to the slit 54 (creating a line of pixels as mentioned above) and inputted into the monolithic Offner spectrometer. The rolling optical lens 42 to collect the image can replace the need for a moveable stage or a mirror galvanometer. The rolling optical lens 42 can replace, modify, and/or simplify the fore-optic lens system used in the art.

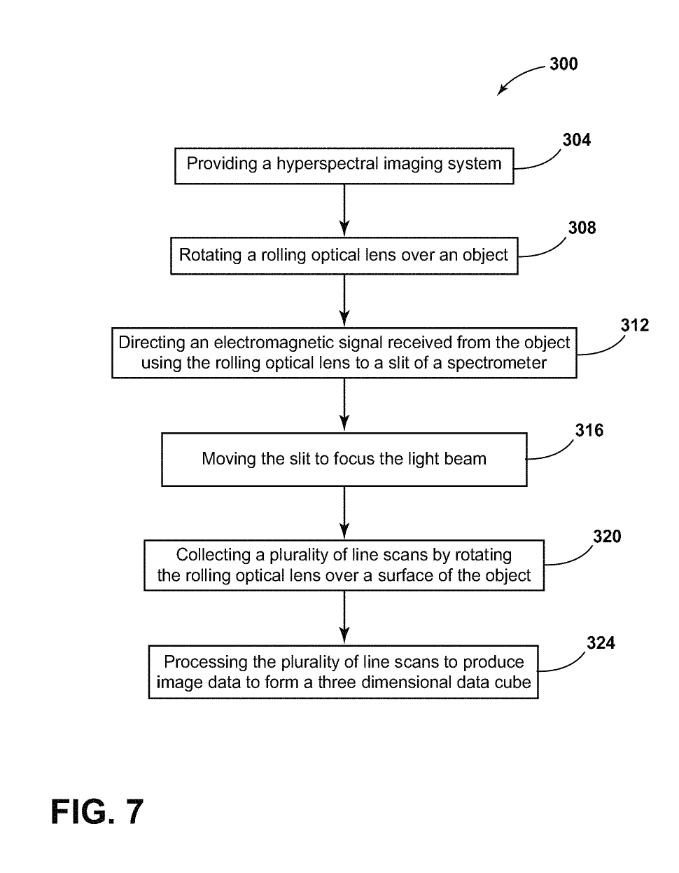

Referring now to FIG. 7, a method 300 of acquiring the image from the patient is provided. The method 300 of acquiring the image from the patient includes providing the hyperspectral imaging system 10 in step 304. The hyperspectral imaging system 10 includes in one embodiment the housing 14, the fore-optics module 26 including the rolling optical lens 42 wherein the fore-optics module 26 is coupled to the housing 14 and wherein the fore-optics module 26 is configured to receive the electromagnetic signal 30 from the patient, the Offner spectrometer 50 coupled inside the housing 14, and the detector 38 coupled to the housing 14. The method 300 of acquiring the image from the patient further includes rotating the rolling optical lens 42 over the patient in step 308, focusing the electromagnetic signal 30 received from the patient using the rolling optical lens 42 on the slit 54 of the Offner spectrometer 50 in step 312 wherein the slit 54 is a moveable slit 54 to focus the electromagnetic signal 30 in step 316, collecting a plurality of line scans wherein each line scan is collected by manually or mechanically rolling or rotating the rolling optical lens 42 over the surface of the patient in step 320, and processing the plurality of line scans to form the three dimensional data space in step 324.

It is understood that the descriptions outlining and teaching the hyperspectral imaging system 10 and methods for imaging a patient previously discussed, which can be used in any combination, may be applied equally as well where applicable to method 300 disclosed for acquiring an image from the patient using the hyperspectral imaging system 10.

Some of the advantages to using this rolling optical lens 42 and methods 200 and 300 are: ease of use; ease of cleaning; and flexibility of use. With the Pushbroom Officer hyperspectral imaging system used in the art, either the object or the camera must move. In clinical or surgical applications, it would be very difficult to instruct a patient to move at a constant rate. Building a device which moves the imaging device may also be difficult because in addition to keeping the patient still, the imaging device would likely be difficult to use at the bedside and/or operating room. Although using a mirror galvanometer can solve some of the movement issues, it will likely require additional stabilization or will confine the system to a specific geometrical configuration. The rolling optical lens 42 and respective hyperspectral imaging system 10 described herein are designed to be used as a hand-held device, which can be used on a variety of locations on and in the body during clinical examinations or surgical procedures. In clinical applications using this hyperspectral imaging system 10, the hyperspectral imaging system 10 may only be cleaned/sterilized between uses. Because it may be difficult to appropriately clean this hyperspectral imaging system 10 without damaging the sensitive detectors and electronics in some embodiments, a portion of the fore-optics module 26 may be disposable. In some embodiments, either the entire rolling optical lens 42 may be disposable or a disposable cover may be placed over the rolling optical lens 42. For cost effectiveness, the disposable cover embodiment may be used.

It will be understood by one having ordinary skill in the art that construction of the described device and other components is not limited to any specific material. Other exemplary embodiments of the device disclosed herein may be formed from a wide variety of materials, unless described otherwise herein.

For purposes of this disclosure, the term “coupled” (in all of its forms, couple, coupling, coupled, etc.) generally means the joining of two components (electrically, optically, and/or mechanically) directly or indirectly to one another. Such joining may be stationary in nature or movable in nature. Such joining may be achieved when the two components and any additional intermediate members are integrally formed as a single unitary body with one another or with the two components. Such joining may be permanent in nature or may be removable or releasable in nature unless otherwise stated.

It is also important to note that the construction and arrangement of the elements of the device as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above is merely for illustrative purposes and not intended to limit the scope of the device, which is defined by the following claims as interpreted according to the principles of patent law, including the Doctrine of Equivalents.

### Listing of Non-Limiting Embodiments

Embodiment A is a hyperspectral imaging system. The hyperspectral imaging system includes a fore-optics module configured to receive an electromagnetic signal from an object, the fore-optics module comprising a rolling optical lens, a wavelength-dispersing module configured to receive the electromagnetic signal form the fore-optics module, and a detector configured to receive the electromagnetic signal from the wavelength-dispersing module.

The system of Embodiment A wherein the rolling optical lens is a spherical lens.

The system of Embodiment A or Embodiment A with any one of the intervening features wherein the rolling optical lens is an aspherical lens.

The system of Embodiment A or Embodiment A with any one of the intervening features wherein the rolling optical lens is a cylindrical lens.

The system of Embodiment A or Embodiment A with any one of the intervening features wherein the rolling optical lens is a ball lens.

The system of Embodiment A or Embodiment A with any one of the intervening features wherein the wavelength-dispersing module is a spectrometer.

The system of Embodiment A or Embodiment A with any one of the intervening features wherein the Offner spectrometer includes: a slit configured for receiving and passing the electromagnetic signal to an entrance surface of the fore-optics module, a first mirror configured for receiving and reflecting the electromagnetic signal passed through the slit, a diffraction grating configured for receiving and diffracting the electromagnetic signal reflected by the first mirror, and a second mirror configured for receiving and reflecting the electromagnetic signal diffracted by the diffraction grating.

The system of Embodiment A or Embodiment A with any one of the intervening features wherein the slit is a moveable slit.

The system of Embodiment A or Embodiment A with any one of the intervening features further comprising a gyroscope or an accelerometer configured to control the moveable slit.

The system of Embodiment A or Embodiment A with any one of the intervening features wherein the moveable slit is weighted and moves under the effects of gravity.

The system of Embodiment A or Embodiment A with any one of the intervening features wherein the object is a patient.

The system of Embodiment A or Embodiment A with any one of the intervening features wherein the object comprises biological tissue.

The system of Embodiment A or Embodiment A with any one of the intervening features further including a housing, the housing enclosing the wavelength-dispersing module.

Embodiment B is a method of acquiring an image from an object. The method of acquiring an image from an object includes providing a hyperspectral imaging system. The hyperspectral imaging system includes a fore-optics module comprising a rolling optical lens, a wavelength-dispersing module, and a detector. The method for acquiring an image further includes rotating the rolling optical lens over the object.

The method of Embodiment B wherein the rolling optical lens is a spherical lens.

The method of Embodiment B or Embodiment B with any of the intervening features wherein the rolling optical lens is a cylindrical lens.

The method of Embodiment B or Embodiment B with any of the intervening features wherein the wavelength-dispersing module is an Offner spectrometer including: a slit configured for receiving and passing an electromagnetic signal received from the fore-optics module, a first mirror configured for receiving and reflecting the electromagnetic signal passed through the slit, a diffraction grating configured for receiving and diffracting the electromagnetic signal reflected by the first mirror, and a second mirror configured for receiving and reflecting the electromagnetic signal diffracted by the diffraction grating.

The method of Embodiment B or Embodiment B with any of the intervening features wherein the slit is a moveable slit configured to focus the electromagnetic signal received from the fore-optics module.

The method of Embodiment B or Embodiment B with any of the intervening features further including: collecting a line scan as the rolling optical lens is rotated over the object, the collecting including acquiring an electromagnetic signal from the object and directing the electromagnetic signal to the fore-optics module, the fore-optics module receiving the electromagnetic signal and directing the electromagnetic signal to the wavelength-dispersing module, the wavelength-dispersing module receiving the electromagnetic signal directed by the fore-optics module and directing the electromagnetic signal to the detector, the detector receiving the electromagnetic signal directed by the wavelength-dispersing module and producing image data from the electromagnetic signal.

The method of Embodiment B or Embodiment B with any of the intervening features wherein the collecting is repeatedly performed to produce a plurality of the line scans, the detector producing image data from each of the plurality of line scans.

The method of Embodiment B or Embodiment B with any of the intervening features further including processing the image data, wherein the processing includes generation of a three dimensional hyperspectral data cube.

Embodiment C is a method of acquiring an image. The method of acquiring an image includes providing a hyperspectral imaging system. The hyperspectral imaging system includes a fore-optics module comprising a rolling optical lens, the fore-optics module is configured to receive an electromagnetic signal from an object, an Offner spectrometer configured to receive the electromagnetic signal from the fore-optics module, and a detector configured to receive the electromagnetic signal from the Offner spectrometer. The method of acquiring an image further includes rotating the rolling optical lens over the object, the rotating including acquiring the electromagnetic signal from the object and directing the electromagnetic signal acquired by the rolling optical lens to a slit of the Offner spectrometer, the electromagnetic signal passing through the Offner spectrometer to the detector.

The method of Embodiment C wherein the rolling optical lens is a spherical lens.

The method of Embodiment C or Embodiment C with any of the intervening features wherein the rolling optical lens is a cylindrical lens.

The method of Embodiment C or Embodiment C with any of the intervening features wherein the moveable slit is weighted and moves freely under the effects of gravity.

The method of Embodiment C or Embodiment C with any of the intervening features wherein the slit is a moveable slit.

The method of Embodiment C or Embodiment C with any of the intervening features wherein the electromagnetic signal is a line scan.

The method of Embodiment C or Embodiment C with any of the intervening features wherein the detector produces image data from the line scan.

What is claimed is:

1. A hyperspectral imaging system, comprising:
a fore-optics module configured to receive an electromagnetic signal from an object, the fore-optics module comprising a rolling optical lens;
a wavelength-dispersing module configured to receive the electromagnetic signal from the fore-optics module; and
a detector configured to receive the electromagnetic signal from the wavelength-dispersing module.

2. The hyperspectral imaging system of claim 1, wherein the rolling optical lens is an aspherical lens.

3. The hyperspectral imaging system of claim 1, wherein the rolling optical lens is a cylindrical lens.

4. The hyperspectral imaging system of claim 1, wherein the rolling optical lens is a ball lens.

5. The hyperspectral imaging system of claim 1, wherein the wavelength-dispersing spectrometer is an Offner spectrometer.

6. The hyperspectral imaging system of claim 5, wherein the Offner spectrometer comprises:
a slit configured for receiving and passing the electromagnetic signal to an entrance surface of the fore-optics module;
a first mirror configured for receiving and reflecting the electromagnetic signal passed through the slit;
a diffraction grating configured for receiving and diffracting the electromagnetic signal reflected by the first mirror; and
a second mirror configured for receiving and reflecting the electromagnetic signal diffracted by the diffraction grating.

7. The hyperspectral imaging system of claim 6, wherein the slit is a moveable slit.

8. The hyperspectral imaging system of claim 1, wherein the object comprises biological tissue.

9. A method of acquiring an image from an object, the method comprising:
providing a hyperspectral imaging system, the hyperspectral imaging system comprising:
a fore-optics module comprising a rolling optical lens;
a wavelength-dispersing module; and
a detector; and
rotating the rolling optical lens over the object.

10. The method of claim 9, wherein the rolling optical lens is a spherical lens.

11. The method of claim 9, wherein the rolling optical lens is a cylindrical lens.

12. The method of claim 9, wherein the wavelength-dispersing module is an Offner spectrometer comprising:
a slit configured for receiving and passing an electromagnetic signal received from the fore-optics module;
a first mirror configured for receiving and reflecting the electromagnetic signal passed through the slit;
a diffraction grating configured for receiving and diffracting the electromagnetic signal reflected by the first mirror; and
a second mirror configured for receiving and reflecting the electromagnetic signal diffracted by the diffraction grating.

13. The method of claim 12, wherein the slit is a moveable slit configured to focus the electromagnetic signal received from the fore-optics module.

14. The method of claim 9, further comprising:
collecting a line scan as the rolling optical lens is rotated over the object, the collecting including acquiring an electromagnetic signal from the object and directing the electromagnetic signal to the fore-optics module, the fore-optics module receiving the electromagnetic signal and directing the electromagnetic signal to the wavelength-dispersing module, the wavelength-dispersing module receiving the electromagnetic signal directed by the fore-optics module and directing the electromagnetic signal to the detector, the detector receiving the electromagnetic signal directed by the wavelength-dispersing module and producing image data from the electromagnetic signal.

15. A method of acquiring an image, the method comprising:
providing a hyperspectral imaging system, the hyperspectral imaging system comprising:
a fore-optics module comprising a rolling optical lens, the fore-optics module is configured to receive an electromagnetic signal from an object;
an Offner spectrometer configured to receive the electromagnetic signal from the fore-optics module; and
a detector configured to receive the electromagnetic signal from the Offner spectrometer; and
rotating the rolling optical lens over the object, the rotating including acquiring the electromagnetic signal from the object; and
directing the electromagnetic signal acquired by the rolling optical lens to a slit of the Offner spectrometer, the electromagnetic signal passing through the Offner spectrometer to the detector.

16. The method of claim 15, wherein the rolling optical lens is a spherical lens.

17. The method of claim 15, wherein the rolling optical lens is a cylindrical lens.

18. The method of claim 15, wherein the moveable slit is weighted and moves freely under the effects of gravity.

19. The method of claim 15, wherein the slit is a moveable slit.

20. The method of claim 15, wherein the electromagnetic signal is a line scan.
